(19) United States
(12) Patent Application Publication
(10) Pub. No.: US 2010/0052347 A1
(43) Pub. Date: Mar. 4, 2010

(54) Server tongs with side cross-over arms

(76) Inventor: Eric Y. Teng, Gold River, CA (US)

Correspondence Address: ERIC TENG, 12089 Gold Pointe Lane, Gold River, CA, 95670, US

(21) Appl. No.: 12/583,826

(22) Filed: Aug. 25, 2009

Related U.S. Application Data
(60) Provisional application No. 61/190,484, filed on Aug. 28, 2008.

(51) Int. Cl. A47J 43/28; B25B 9/02; A47G 21/10

(52) U.S. Cl. 294/99.2

(57) ABSTRACT

A pair of tongs having two elongated forearms that adjoin their respective crossovers that transform the upper forearm into the lower handle means and the lower forearm into the upper handle means. The upper and lower handle means adjoin via a bias close spring that supports the two forearms in a bias open position via the crossovers. This pair of tongs can be easily used to handle food and other materials through hand-squeezing action applied to its forearms.

### CROSS-REFERENCE TO RELATED APPLICATIONS

This application claims the benefit of provisional patent application Ser. No. 61/190,484, filed on Aug. 28, 2008 by the present inventor.

### FEDERALLY SPONSORED RESEARCH

Not applicable

### SEQUENCE LISTING OR PROGRAM

Not applicable

### REFERENCES CITED

| D253,803 | Daenen |
|---|---|
| 450,266 | Truax |
| 1,545,693 | Phoel |
| 2,634,728 | Dale |
| 4,314,724 | Barna |
| 6,056,342 | Chan |

### BACKGROUND OF THE INVENTION

1. Field of Invention

This invention relates to table-top utensils and kitchen or cooking tools, specifically utensils used as serving implements at a dinning table, as well as kitchen tongs used for cooking.

2. Prior Art

Cooking tongs are generally of the V-shaped type having two elongated arms connected through a bias open spring-hinge with food-grasping implement forming a jaw at the front end. During use, a user will grasp the pair of tongs and exert a gripping force to overcome the bias open force to allow food material to be grasped by the jaw. Often a locking mechanism is included that enables the pair of tongs to remain lock-closed when not being in use.

Tongs of this construction unfortunately are not well-adapted for use as server tongs at a dinning table because the utilitarian construction does not provide for an elegant design demanded of server tongs used for such purposes.

Another commonly seen simple U-shaped tongs design often uses a long strip of metal that is bent at 180 degrees. Other tongs with this similar U-shaped construction can also be made with plastic, wood, bamboo or other materials. Regardless, this design with its utter simplicity does not provides for the inclusion of a locking mechanism. Therefore the two arms of the unit would always remain open even when not in use. This tends to make the pair of tongs unsightly while taking up much space, again making tongs of this construction undesirable for use at a dinning table.

Yet another popular tongs design utilizes a scissors-like construction such as commonly seen in salad server tongs. This design has the disadvantage of having a complicated bulky design that is again both unsightly and space-consuming.

There exists on the market some other tongs of a cross-over design that may appear at first glance to be similar to the invention. Most of these are for specialized usages for example, as escargot servers, ice tongs, sugar tongs, or hair tweezers, or sometimes as pincers for laboratory use. A typical example of such tongs can be seen in Chan U.S. Pat. No. 6,056,342. However, all prior art tongs with a crossover design are exclusively of the bias close design with a bias open spring such that a user would have to exert a pinching force at the primal or handle side of the crossover in order to force open the pair of tongs while releasing it would allow the bias close force of the pair of tongs to grip the food or material at its distal end (note the bias open spring in such devices cause a bias close force at the gripping end via the crossover).

The disadvantage of this bias close crossover design is that food or material that is grasped at its jaw is held in position only by the fixed spring force which could be too strong or too weak for the purpose intended. This may explain why tongs or implements of this design are almost exclusively designed for single purpose use in the handling of a certain type of food or material.

Because of the above disadvantages, proper server tongs for use at a dinning table is largely absent from the market, despite their obvious market demand especially for serving food which otherwise would be hard to handle and would often require two-handed handling using separate serving spoons or serving forks.

### OBJECTS AND ADVANTAGES

Several objects and advantages of the present invention are:
a) to provide a pair of simple tongs that can be used to serve longish food that would otherwise be difficult to handle using only one hand;
b) to provide a pair of simple tongs with a structure well-adapted for further esthetic design to achieve exceptional elegant looks;
c) to provide a pair of simple tongs that has a built-in locking mechanism while retaining its simple elegant looks;
d) to provide a pair of simple tongs that has exceptional handling and balance;
e) to provide a pair of simple tongs that is easy and inexpensive to be mass produced.

Further objects and advantages will become apparent from a consideration of the ensuing description and drawings.

### SUMMARY

In accordance with the present invention a pair of bias open tongs comprises two elongated forearms that transform into a handle via a crossover turning its upper forearm into its lower handle means and its lower forearm into its upper handle means with a bias close spring therein connecting the upper and lower handle means. This pair of tongs with its simple elegant design can be lock-closed by a thumb switch and can be conveniently used as a pair of server tongs for serving food at a dining table for both formal and casual occasions.

### DRAWINGS

### Figures

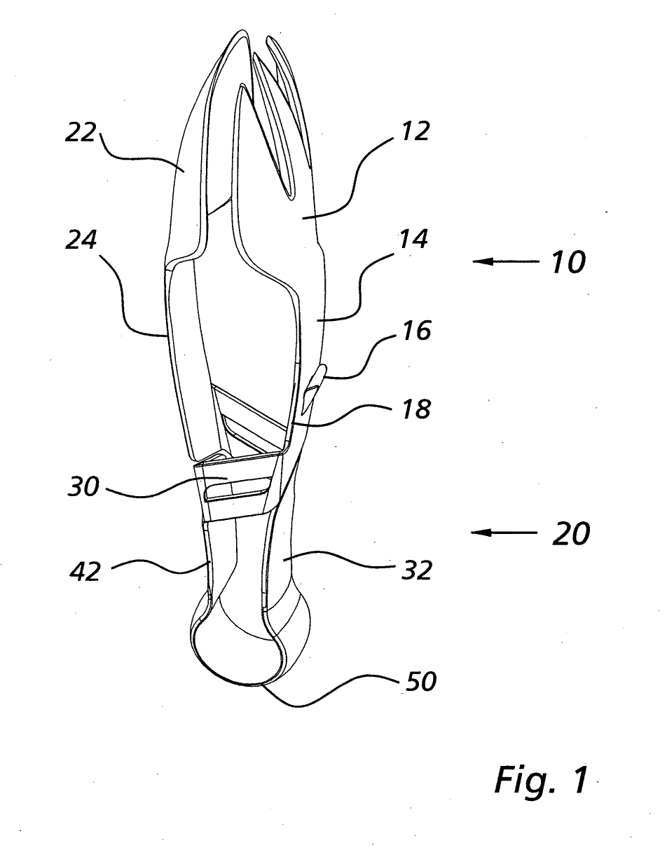

FIG. 1 shows a 3-D view of the pair of tongs having a cross-over construction

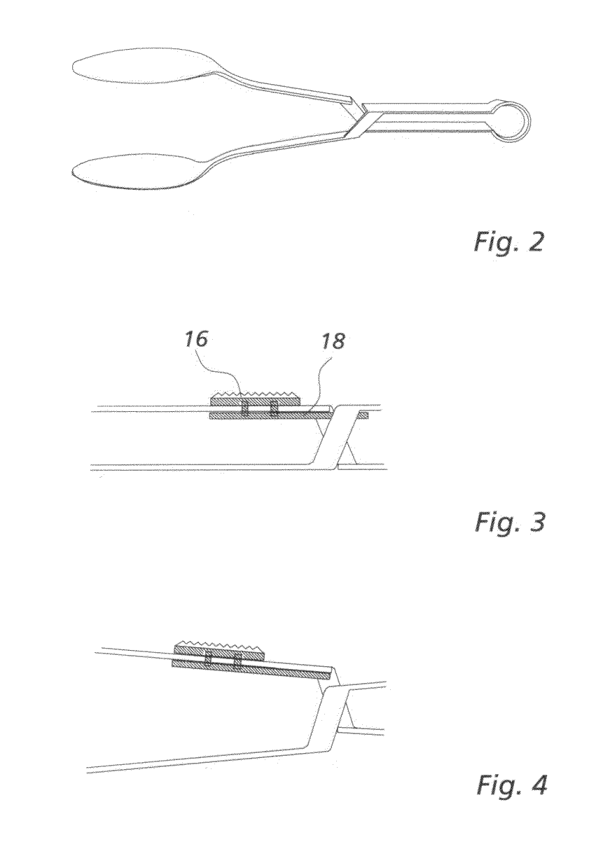

FIG. 2 shows the same pair of tongs in a bias open position without external force

FIG. 3 shows a locking mechanism with the tongs in a close-locked position

FIG. 4 shows a locking mechanism with the tongs in an open-unlocked position

### Reference Numerals

10 Fore or food-gripping Section
12 Upper food-gripping implement in the shape of a fork
22 Lower food-gripping implement in the shape of a spoon
14 Upper forearm
24 Lower forearm
16 Sliding Thumb Switch
18 Slidable Latch on the inner side of the upper forearm
20 Rear or handle section
30 Crossover
32 Upper handle means
42 Lower handle means
50 Bias close spring

### DETAIL DESCRIPTION OF THE DRAWINGS

### Preferred Embodiment

As can be seen in the drawings, a pair of bias open tongs can be constructed with a Crossover 30 separating its Fore or Food-Gripping Section 10 from its Rear or Handle Section 20. During use, the user's thumb and first finger are positioned within the Food-gripping Section 10 of the pair of tongs in proximity to the Crossover 30 while the rest of his hand is holding the Rear or Handle Section 20 with the Spring 50 resting in his palm.

The Spring 50 has a bias close force forcing the Upper Handle Means 32 and Lower Handle Means 42 to be closed at rest. From the construction shown in FIG. 2, this bias close handle would force the Food-gripping Section 10 including the Upper and Lower Forearms 14 and 24 and the Upper and Lower Food-gripping Implements 12 and 22 to be bias open as the Upper and Lower Handle Means cross-over each other “flipping sides” at the Crossover 30 thus transforming them into the Lower Forearm 24 and Upper Forearms 14 respectively.

In other words, this crossover design turns the pair of tongs into a bias open pair of tongs although the Spring 50 is a bias close spring. This pair of tongs can now be conveniently hand-operated by the user through a hand-squeezing action as if a pair of traditional tongs is being used.

A mechanical locking mechanism can be included on the two elongated Forearms 14 and 24 as shown in FIG. 3 and FIG. 4 so as to enable the pair of tongs to be lock-closed when it is not in use. An example of a simple latching mechanism formed by a Thumb Switch 16 and a Latch 18 is shown to demonstrate how this can be accomplished.

A close study of the thumb switch—latch lock mechanism reveals that if the thumb switch is eliminated and the latch be made to be very loose, then the latch would fall to its bottom position by virtue of gravity if the pair of tongs is held in a vertical position. If a user points the pair of tongs upwards while forcing its forearms to close, then the Latch 18 would fall from its upper forefront location on the tongs to its upper rear location. If the user now releases his grip, then Latch 18 will lock close the pair of tongs. For unlocking the pair of tongs, a user would only need to point the pair of tongs downwards and slightly press the forearms together. Then Latch 18 will drop back into its upper forefront location thereby unlocking the pair of tongs. This shows how simple gravity locks can be easily designed by anyone skilled in the art.

It would be fair to say that any traditional pair of tongs, for example those having a simple U-bend or simple scissors construction, or a pair of V-shaped cooking tongs having a spring at the joining hinge, can all be used for food-serving purposes. However, none of these common constructions is adaptable for further design to achieve the elegant look that is required for tongs used at a dining table, especially for use at more formal occasions. This is probably the explanation for the surprising absence of dinner server tongs on the market despite the obvious usefulness of such an implement. This is quite unlike what can be easily achieved with the simple and elegant crossover construction of the present invention.

For the purpose of picking up food, it would be useful if the server tongs is designed to have a pair of matching implements such as spoons, forks, or a combination of such to be its food gripping jaw rather then the scalloped head of common cooking tongs. Other variations in design for the gripping implement end such as in the simple shape of a pair of pincers or chopsticks can also be adopted for other specialized purposes such as for picking up ice or olives etc. In some cases, no obvious “implements” are included in the design but such “implement” would just be the ends of the forearms of the pair of tongs used in grabbing food and other material just as well as those with recognizable implements.

1) A material handling tool, comprising: an elongated upper forearm, an elongated lower forearm, an elongated upper handle means, an elongated lower handle means, a first crossover adjoining said upper forearm and said lower handle means, a second crossover adjoining said lower forearm and said upper handle means, a bias close spring means adjoining said upper and lower handle means, wherein said bias close spring forces said upper and lower forearms to bias away from each other via said crossovers; whereby said tool can be conveniently used by a user to handle food and other materials.

2) Said tool of claim 1 further including a manual switch-latch means.

3) Said tool of claim 1 further including a gravity manual switch-latch means.

4) Food and material handling tongs comprising: a pair of elongated tong members having a upper fore section, a lower fore section, an upper rear section, a lower rear section, a first and second crossover, a bias close spring means; said upper fore section adjoin said lower rear section via said first crossover; said lower fore section adjoin said upper rear section via said second crossover; said upper and lower rear sections adjoin via said bias close spring means; said elongated tong members bias away from each other as urged by said bias close spring means via said crossovers; whereby said tongs can be conveniently used by a user to handle food and other materials.

5) Said tongs of claim 4 further including a manual switch-latch means.

6) Said tongs of claim 4 further including a gravity manual switch-latch means

7) A pair of bias open tongs comprising: a bias close spring means, a pair of upper and lower material-gripping implements, a pair of upper and lower forearms, a pair of first and second crossovers, a pair of upper and lower handle means; said upper material-gripping implement adjoining said upper forearm; said upper forearm adjoining said first crossover; said first crossover adjoining said lower handle means; said lower handle means adjoining said spring means; said spring means adjoining said upper handle means; said upper handle means adjoining said second crossover; said second crossover adjoining said lower forearm, said lower forearm adjoining said lower material-gripping implement; said upper and lower material-gripping implements bias away from each other; whereby said pair of tongs can be conveniently used by a user to handle food and other materials.

8) Said tongs of claim 7 further including a manual switch-latch means.

9) Said tongs of claim 7 further including a gravity manual switch-latch means
